(19) United States
(12) Patent Application Publication
(10) Pub. No.: US 2026/0093284 A1
(43) Pub. Date: Apr. 2, 2026

(54) ELECTRONIC DEVICE

(71) Applicant: Lenovo (Beijing) Limited, Beijing (CN)

(72) Inventors: Sai GAO, Beijing (CN); Kai Zhang, Beijing (CN)

(21) Appl. No.: 19/337,416

(22) Filed: Sep. 23, 2025

(30) Foreign Application Priority Data
Sep. 30, 2024 (CN) 202411392148.4

(51) Int. Cl. G06F 1/16

(52) U.S. Cl. CPC G06F 1/1624; G06F 1/1616; G06F 1/1652; G06F 1/1681

(57) ABSTRACT

An electronic device includes a first body and a second body. The first body includes: a first sub-body and a second sub-body and a flexible screen that includes a first part on the first sub-body, a second part on the second sub-body, and a connection part there-between. The first and second parts are able to rotate through the connection part. The second body is rotatably connected to an end of the first sub-body through a connection device. The second body is able to rotate relative to the first sub-body through the connection device. A part where the connection device is connected to the first sub-body is located between a first top wall and a first bottom wall of the first sub-body. A part where the connection device is connected to the second body is located between a second top wall and a second bottom wall of the first body.

### CROSS-REFERENCE TO RELATED APPLICATION

This application claims priority to Chinese Patent Application No. 202411392148.4, filed on Sep. 30, 2024, the entire content of which is incorporated herein by reference.

### TECHNICAL FIELD

The present disclosure generally relates to the field of electronic technologies and, more particularly, to an electronic device.

### BACKGROUND

Electronic devices are devices that people often use. In existing technologies, two bodies of an electronic device are rotationally connected via a rotating shaft structure.

### SUMMARY

In accordance with the present disclosure, there is provided an electronic device. The electronic device includes a first body and a second body. The first body includes: a first sub-body and a second sub-body, which are able to rotate relative to each other, and a flexible screen. The flexible screen includes a first part on the first sub-body, a second part on the second sub-body, and a connection part between the first part and the second part. The first part and the second part are able to rotate through the connection part as the first sub-body and the second sub-body rotate relative to each other. The second body is rotatably connected to an end of the first sub-body away from the second sub-body through a connection device. The second body is able to rotate relative to the first sub-body through the connection device until it satisfies a coplanar condition with the first sub-body. A part where the connection device is connected to the first sub-body is located between a first top wall and a first bottom wall of the first sub-body. A part where the connection device is connected to the second body is located between a second top wall and a second bottom wall of the first body.

### BRIEF DESCRIPTION OF THE DRAWINGS

FIG. 1 is a schematic structural diagram of an exemplary electronic device where a connection device is in a first state, consistent with various embodiments of the present disclosure.

FIG. 2 is a schematic structural diagram of an exemplary electronic device where a connection device is in a second state, consistent with various embodiments of the present disclosure.

FIG. 3 is a view from another angle of an electronic device in FIG. 2 consistent with various embodiments of the present disclosure.

FIG. 4 is a cross-sectional view of an exemplary electronic device where an angle between a second body and a first body is about 135 degrees, consistent with various embodiments of the present disclosure.

FIG. 5 is a cross-sectional view of an exemplary electronic device where a connection device is in a second state, consistent with various embodiments of the present disclosure.

FIG. 6 is a cross-sectional view of a partial structure of an electronic device in FIG. 1, consistent with various embodiments of the present disclosure.

FIG. 7 is an exploded view of a partial structure of an electronic device in FIG. 6, consistent with various embodiments of the present disclosure.

FIG. 8 is a cross-sectional view of a partial structure of an electronic device in FIG. 1, consistent with various embodiments of the present disclosure.

FIG. 9 is a cross-sectional view of a partial structure of an electronic device in FIG. 8, consistent with various embodiments of the present disclosure.

FIG. 10 is an exploded view of a partial structure of an electronic device in FIG. 9, consistent with various embodiments of the present disclosure.

FIG. 11 is a schematic structural diagram of an exemplary connection device in a first state, consistent with various embodiments of the present disclosure.

FIG. 12 is an exploded view of a connection device in FIG. 11, consistent with various embodiments of the present disclosure.

FIG. 13 is a cross-sectional view of a shaft assembly of a connection device in FIG. 11, consistent with various embodiments of the present disclosure.

FIG. 14 is a schematic structural diagram of an exemplary connection in a second state, consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

Unless otherwise defined, all technical and scientific terms used in the present disclosure have the same meaning as those generally understood by those skilled in the art to which the present disclosure belongs. The terms used herein are only for the purpose of describing the present disclosure and are not intended to limit the scope of the present disclosure.

In the following description, “some embodiments”, “this embodiment”, one embodiment”, and “examples”, etc., describe subsets of all possible embodiments. But it is understood that “some embodiments” can be the same subset or different subsets of all possible embodiments, and can be combined with each other without conflict.

In the following description, the terms “first/second/third” or similar terms involved are only used to distinguish similar objects, and do not represent a specific order for the objects. It is understandable that items described by “first/second/third” may be interchanged with a specific order or sequence where permitted, such that the present disclosure described here can be implemented in an order other than that illustrated or described here.

In the present disclosure, the term “and/or” is only a kind of association relationship describing associated objects, indicating that there can be three types of relationships. For example, “object A and/or object B” may represent: object A exists alone, object A and object B exist at the same time, or object B exists alone.

With the development of electronic device technology, the user experience brought by the appearance of electronic devices is becoming more and more important, and consumers are paying more and more attention to the user experience brought by the appearance of electronic devices. In existing technologies, multiple bodies of an electronic device are connected by a rotating shaft structure. For example, multiple bodies of the electronic device are connected by a multi-stage rotating shaft structure. However, since the multi-stage rotating shaft structure is in an exposed state, it affects the user experience of the appearance of the electronic device.

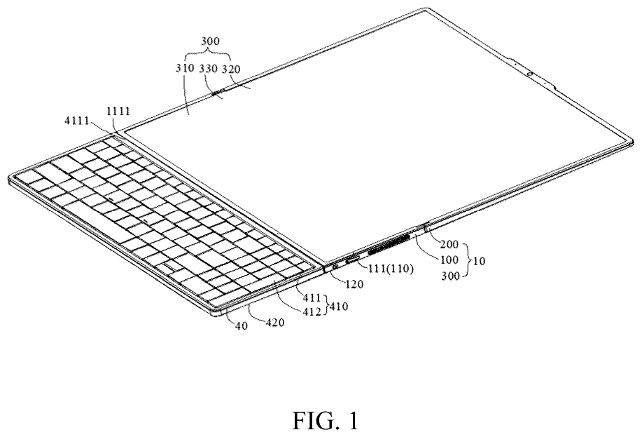

The present disclosure provides an electronic device to at least partially alleviate the above problems. The electronic device provided by the present disclosure will be described in detail in conjunction with FIG. 1 to FIG. 14.

In one embodiment, the electronic device may include: a first body 10, a second body 40, and a connection device 50. The first body 10 may include: a first sub-body 100 and a second sub-body 200 that are able to rotate relative to each other, and a flexible screen 300. The flexible screen 300 may include a first part 310 disposed on the first sub-body 100, a second part 320 disposed on the second sub-body 200, and a connection part 330 located between the first part 310 and the second part 320. The first part 310 and the second part 320 may be able to rotate through the connection part 330 as the first sub-body 100 and the second sub-body 200 rotate relative to each other. The second body 40 may be rotatably connected to an end of the first sub-body 100 away from the second sub-body 200 through the connection device 50. The second body 40 may be able to rotate relative to the first sub-body 100 through the connection device 50 to meet a coplanar condition with the first sub-body 100. A part where the connection device 50 is connected to the first sub-body 100 may be located between a first top wall 110 and a first bottom wall 120 of the first sub-body 100. A part where the connection device 50 is connected to the second body 40 may be located between a second top wall 410 and a second bottom wall 420 of the first body 10.

In the present disclosure, since the part where the connection device 50 is connected to the first sub-body 100 is located between the first top wall 110 and the first bottom wall 120 of the first sub-body 100, and the part where the connection device 50 is connected to the second body 40 is located between the second top wall 410 and the second bottom wall 420 of the second body 40, the connection device 50 may be hidden. As shown in FIG. 1, since the connection device 50 is hidden, the connection device 50 may not occupy a space of the first top wall 110 of the first sub-body 100, and it may also not occupy a space of the second top wall 410 of the second body 40. Therefore, the utilization rate of the first top wall 110 of the first sub-body 100 may be improved. For example, the setting area of the flexible screen 300 on the side of the first top wall 110 of the first sub-body 100 may be increased, thereby realizing a larger area of the flexible screen 300. Also, the utilization rate of the second top wall 410 of the second body 40 may be improved. For example, when an input component 412 is set on the side of the second top wall 410, the setting area of the input component 412 on the side of the second top wall 410 of the second body 40 may be increased, to achieve a larger area of the input component 412. Further, the adjacent areas on the side of the first top wall 110 of the first sub-body 100 and on the side of the second top wall 410 of the second body 40 may also be set more neatly, such that the appearance of the electronic device is neater.

In the present disclosure, the structure of the electronic device is not limited. For example, the electronic device may be a laptop computer. For another example, the electronic device may be a tablet computer.

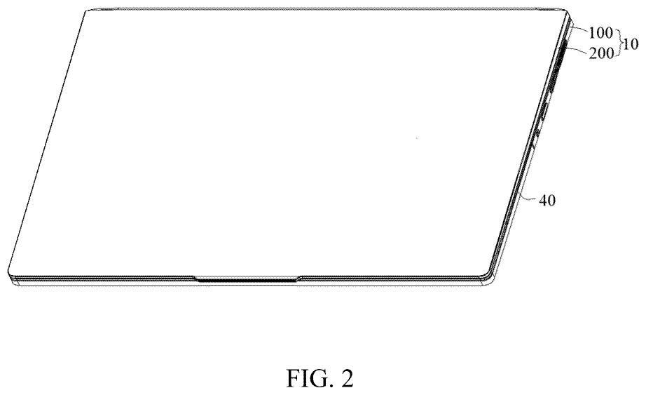

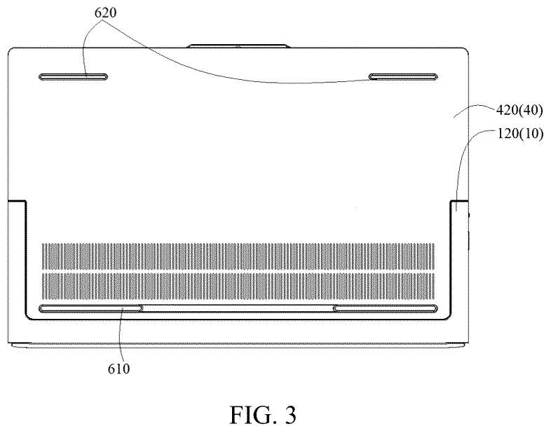

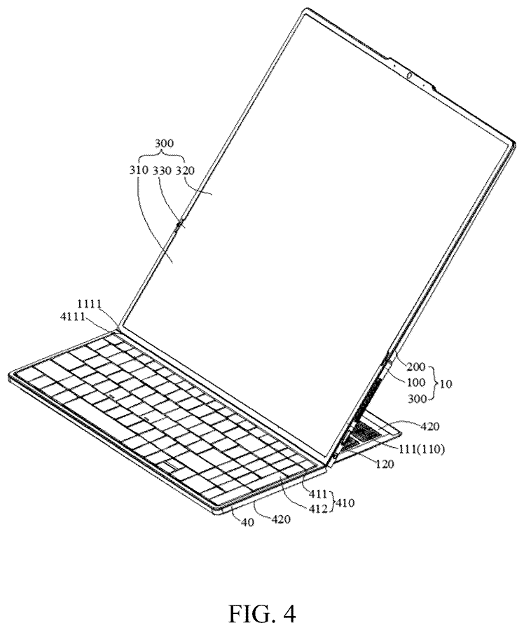

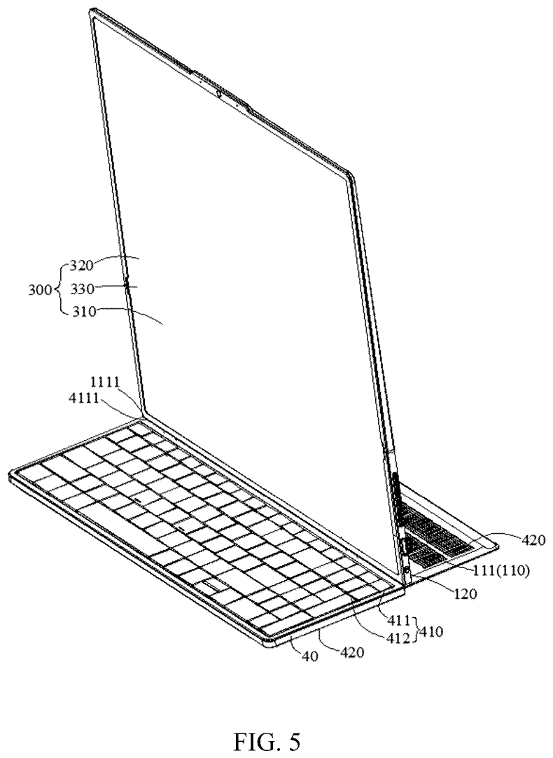

In one embodiment of the present disclosure, the first sub-body 100 and the second sub-body 200 may be rotatably connected through a rotating shaft structure. The first sub-body 100 may be rotated relative to the second sub-body 200 to meet the coplanar condition, which means that the two bodies are basically at the same level and the structure formed by the two bodies is similar to a flat plate structure. The top surfaces of the two bodies may be basically in the same plane, or the bottom surfaces of the two bodies may also be basically in the same plane. Therefore, the angle between the first sub-body 100 and the second sub-body 200 may be 180 degrees, as shown in FIG. 1, FIG. 4, and FIG. 5. The first sub-body 100 and the second sub-body 200 may form a larger flat structure as a whole. The first sub-body 100 may also be rotated to a folded state relative to the second sub-body 200, where the first sub-body 100 and the second sub-body 200 are stacked together in the thickness direction and the angle between the first sub-body 100 and the second sub-body 200 may be 0 degrees, as shown in FIG. 2 and FIG. 3. Of course, the angle between the first sub-body 100 and the second sub-body 200 may also vary between 0 degrees and 180 degrees, such that a variety of structural forms are formed between the first sub-body 100 and the second sub-body 200.

In one embodiment of the present disclosure, the first part 310 of the flexible screen 300 may be fixed to the first sub-body 100 by means of a snap connection, bonding, etc. The second part 320 of the flexible screen 300 may be fixed to the second sub-body 200 by means of snap connection, bonding, etc. The connection part 330 of the flexible screen 300 may not be fixed, such that the connection part 330 of the flexible screen 300 may be deformed as the first sub-body 100 and the second sub-body 200 rotate relative to each other. The shaft structure between the first sub-body 100 and the second sub-body 200 may be similar to the method of two bodies supporting a deformable screen in existing technologies, which will not be repeated here.

In the embodiments of the present disclosure, the structure of the second body 40 is not limited. For example, in one embodiment, the second body 40 may include the input component 412, through which information may be input. The structure of the input component 412 is not limited. For example, in various embodiments, the input component 412 may be a physical keyboard, a writing screen, or a touch screen. It should be noted that the input component 412 and the flexible screen 300 may be two structural members, and the input component 412 and the flexible screen 300 may be arranged at intervals.

The second body 40 may be rotatably connected to the end of the first sub-body 100 away from the second sub-body 200 through the connection device 50, such that the second body 40, the first sub-body 100, and the second sub-body 200 are arranged side by side, as shown in FIG. 1, FIG. 4, and FIG. 5.

The second body 40 may be rotated to a first state or a second state relative to the first sub-body 100 through the connection device 50. The specific forms of the first state and the second state may not be limited.

For example, in one embodiment, as shown in FIG. 1 and FIG. 2, in the first state, the second body 40 and the first sub-body 100 may meet the coplanar condition. The first sub-body 100 and the second body 40 form a larger flat structure as a whole, and the angle between the second body 40 and the first sub-body 100 may be 180 degrees or may be approximately 180 degrees.

For another example, in the second state, the angle between the second body 40 and the first sub-body 100 may be larger than or equal to 90 degrees. As an example, in one embodiment, the angle between the second body 40 and the first sub-body 100 may be equal to 90 degrees, as shown in FIG. 5. For yet another example, the angle between the second body 40 and the first sub-body 100 may be equal to 100 degrees, 95 degrees, 110 degrees, etc.

In the second state, the second body 40 and the first sub-body 100 may form a standing state and may not form a folded state. The second body 40 and the first sub-body 100 may not be stacked together in the thickness direction, and the angle between the second body 40 and the first sub-body 100 may not be less than 90 degrees.

Of course, in other examples, the angle between the second body 40 and the first sub-body 100 may also be larger than or equal to 85 degrees. The angle between the second body 40 and the first sub-body 100 may not be less than 85 degrees.

In the embodiments of the present disclosure, the form of the electronic device formed by the second body 40, the first sub-body 100, and the second sub-body 200 may not be limited. For example, in one embodiment, the second body 40, the first sub-body 100, and the second sub-body 200 may have the same size in the axial direction. In another embodiment, the second body 40, the first sub-body 100, and the second sub-body 200 may have substantially the same size in the axial direction. When the first sub-body 100 and the second body 40 meet the coplanar condition, the width of the first sub-body 100 and the second body 40 as a whole may be the same as the width of the second sub-body 200, or the width of the first sub-body 100 and the second body 40 as a whole may be substantially the same as the width of the second sub-body 200. The overall structure of the first sub-body 100, the second body 40, and the second sub-body 200 may be similar to the two bodies of a laptop computer. The width direction may be perpendicular to the axial direction. The width direction may be perpendicular to the thickness direction.

In the embodiments of the present disclosure, the structure of the connection device 50 is not limited, as long as the part of the connection device 50 connected to the first sub-body 100 is located between the first top wall 110 and the first bottom wall 120 of the first sub-body 100 and the part of the connection device 50 connected to the second body 40 is located between the second top wall 410 and the second bottom wall 420 of the first body 10.

The second bottom wall 420 of the second body 40 may be used to contact a bearing surface to support the electronic device. The bearing surface may be a surface that bears the electronic device. For example, the bearing surface may be a desktop. When the electronic device is in use, the second top wall 410 of the second body 40 may be located on the top side of the electronic device, and the second top wall 410 of the second body 40 may be in an exposed state, as shown in FIG. 1, FIG. 4, and FIG. 5.

A portion of the first bottom wall 120 of the first sub-body 100 may be used to contact the bearing surface to support the electronic device. Another portion of the first bottom wall 120 of the first sub-body 100 may not be used to contact the bearing surface. When the electronic device is in use, the first bottom wall 120 of the first sub-body 100 may be located on the bearing surface side, where the electronic device is similar to a conventional laptop. Of course, in some other embodiments, the first bottom wall 120 of the first sub-body 100 may also be located on the side facing away from the user, as shown in FIG. 4 and FIG. 5. The first top wall 110 of the first sub-body 100 may be located on the side facing the user.

In some optional embodiments of the present disclosure, the first top wall 110 may include a first edge portion 1111 adjacent to the second body 40, and the second top wall 410 may include a second edge portion 4111 adjacent to the first edge portion 1111. The second body 40 may be rotated to the first state or the second state relative to the first sub-body 100 through the connection device 50, and the distance between the first edge portion 1111 and the second edge portion 4111 may be the same in the first state and the second state. In the first state, the second body 40 and the first sub-body 100 may meet a coplanar condition. In the second state, the angle between the second body 40 and the first sub-body 100 may be larger than or equal to 90 degrees. By making the distance between the first edge portion 1111 and the second edge portion 4111 the same in the first state and the second state, the appearance of the area between the second body 40 and the first sub-body 100 in the first state and the second state may be made more uniform, improving the user experience of the electronic device. Therefore, the discomfort caused to the user by the large change in the appearance shape of the electronic device because of the large change in the distance between the second body 40 and the first sub-body 100 may be eliminated.

In the present embodiment, the distance between the first edge portion 1111 and the second edge portion 4111 may not be limited in the first state and the second state. For example, the distance between the first edge portion 1111 and the second edge portion 4111 may be less than 1 mm, less than 0.8 mm, or less than 0.5 mm in the first state and the second state. As an example, the distance between the first edge portion 1111 and the second edge portion 4111 may be 1 mm or 0.5 mm in the first state and the second state. It should be noted that because of manufacturing errors, in the physical product of the electronic device, the distance between the first edge portion 1111 and the second edge portion 4111 may not be exactly the same in the first state and the second state. In other words, the distance between the first edge portion 1111 and the second edge portion 4111 may be substantially the same in the first state and the second state.

In the present embodiment, during the movement of the first sub-body 100 and the second body 40 from the first state to the second state through the connection device 50, the distance between the first edge portion 1111 and the second edge portion 4111 may first decrease and then increase. Of course, in some other embodiments, during the movement of the first sub-body 100 and the second body 40 from the first state to the second state through the connection device 50, the distance between the first edge portion 1111 and the second edge portion 4111 may also be the same.

In one embodiment, the connection device 50 may include at least one connecting structure 510. One connecting structure 510 may include an arc slide 511 and a sliding structure 512 inserted into the arc slide 511. The first sub-body 100 may be able to move relative to the second body 40 along a trajectory defined by the arc slide 511 based on the sliding structure 512 sliding in the arc slide 511, such that the distance between the first edge portion 1111 and the second edge portion 4111 may be the same in the first state and the second state.

In one embodiment, the first edge portion 1111 and the second edge portion 4111 may be located on the top side wall of the electronic device, and the connection device 50 may be located between the top wall and the bottom wall of the electronic device. Since the first sub-body 100 moves based on the trajectory defined by the arc slide 511, the distance between the first edge portion 1111 and the second edge portion 4111 may be the same in the first state and the second state. During the rotation of the first sub-body 100 relative to the second body 40, the distance between the first sub-body 100 and the second body 40 where the connection device 50 is disposed may change, that is, the area of the first sub-body 100 where the connection device 50 is disposed may move away from the first sub-body 100 or close to the first sub-body 100 relative to the second body 40.

For example, in one embodiment, the connection device 50 may include one connection structure 510. The axis A of the arc slide 511 may be located at the second edge portion 4111. A portion of one of the arc slide 511 and the sliding structure 512 may be located between the first top wall 110 and the first bottom wall 120 of the first sub-body 100, and another portion of the one of the arc slide 511 and the sliding structure 512 may be located outside the first sub-body 100. A portion of another one of the arc slide 511 and the sliding structure 512 may be located between the second top wall 410 and the second bottom wall 420 of the second body 40, and another portion of the other one of the arc slide 511 and the sliding structure 512 may be located outside the second body 40. The first sub-body 100 may slide in the arc slide 511 through the sliding structure 512 and rotate around the second edge 4111, such that the distance between the first edge 1111 and the second edge 4111 may always be the same.

In this example, the second edge portion 4111 may be located on the side of the second body 40 close to the first sub-body 100, and the axis A of the arc slide 511 may be located at the second edge portion 4111. When the first sub-body 100 rotates relative to the second body 40, the first sub-body 100 may rotate around the axis A at the second edge portion 4111, such that the distance between each area of the first sub-body 100 and the axis A at the second edge portion 4111 may always be the same. The first edge portion 1111 of the first sub-body 100 may be the area closest to the second body 40 during the rotation of the first sub-body 100 relative to the second body 40. By rotating the first sub-body 100 around the axis A at the second edge portion 4111, the distance between an area between the first sub-body 100 and the second body 40 with a minimum distance may be always the same, which may prevent the first sub-body 100 and the second body 40 from interfering because of the distance being too small and may also make the appearance of the first sub-body 100 and the second body 40 more consistent.

In this example, during the rotation of the first sub-body 100 relative to the second body 40, since the distance between the first edge portion 1111 and the second edge portion 4111 may be always the same, the appearance of the adjacent areas of the first sub-body 100 and the second body 40 may be made more uniform, thereby greatly improving the user experience of the electronic device.

In this example, a portion of one of the arc slide 511 and the sliding structure 512 may be located between the first top wall 110 and the first bottom wall 120 of the first sub-body 100, and another portion of the one of the arc slide 511 and the sliding structure 512 may be located outside the first sub-body 100. A portion of another one of the arc slide 511 and the sliding structure 512 may be located between the second top wall 410 and the second bottom wall 420 of the second body 40, and another portion of the other one of the arc slide 511 and the sliding structure 512 may be located outside the second body 40. One of the arc slide 511 and the sliding structure 512 may be arranged in the first sub-body 100, and the other of the arc slide 511 and the sliding structure 512 may be arranged in the second body 40. The arc slide 511 and the sliding structure 512 may both have portions located outside the arranged structure.

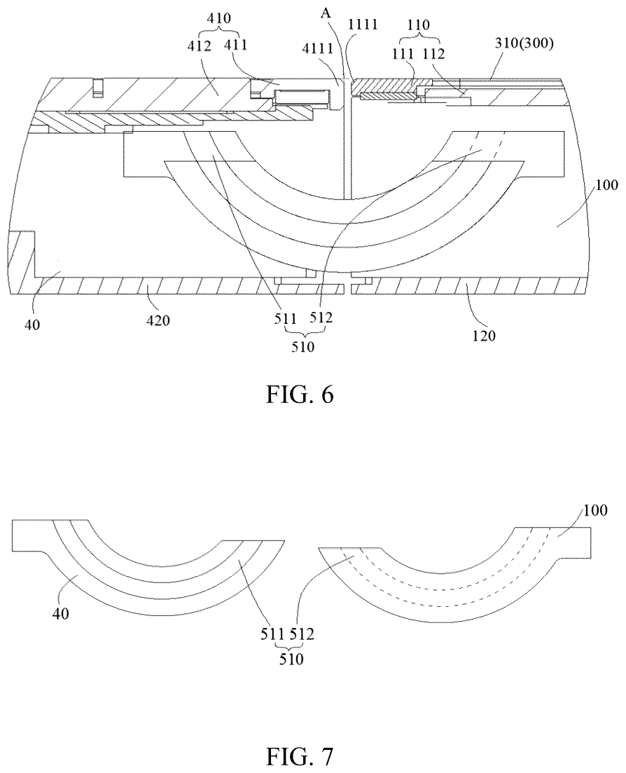

As an example, in one embodiment, the arc slide 511 may be disposed in the second body 40, and the sliding structure 512 may be disposed in the first sub-body 100. A portion of the arc slide 511 may be located between the second top wall 410 and the second bottom wall 420 of the second body 40, and another portion of the arc slide 511 may be located outside the second body 40. A portion of the sliding structure 512 may be located between the first top wall 110 and the first bottom wall 120 of the first sub-body 100, and another portion of the sliding structure 512 may be located outside the first sub-body 100. In the first state, as shown in FIG. 6, the another portion of the arc slide 511 may be located between the first top wall 110 and the first bottom wall 120 of the first sub-body 100, and the another portion of the sliding structure 512 may be located between the second top wall 410 and the second bottom wall 420 of the second body 40.

As another example, in another embodiment, the arc slide 511 may be disposed in the first sub-body 100, and the sliding structure 512 may be disposed in the second body 40. A portion of the arc slide 511 may be located between the first top wall 110 and the first bottom wall 120 of the first sub-body 100, and another portion of the arc slide 511 may be located outside the first sub-body 100. A portion of the sliding structure 512 may be located between the second top wall 410 and the second bottom wall 420 of the second body 40, and another portion of the sliding structure 512 may be located outside the second body 40.

In this example, the arc slide 511 may be a circular arc slide 511. By sliding the sliding structure 512 in the arc slide 511, the sliding structure 512 and the arc slide 511 may be rotatably connected.

In this example, the axis of the arc slide 511 may be located at the second edge portion 4111, or the axis of the arc slide 511 may be located at the corner of the second edge portion 4111. When the second side 4111 may be chamfered, the corner of the second side 4111 may be the theoretical corner of the second side 4111, that is, the axis may be located at the position of the corner when the second side 4111 is not chamfered.

In this embodiment, the shape of the sliding structure 512 is not limited, as long as the sliding structure 512 is able to slide in the arc slide 511 and cannot rotate in the arc slide 511. For example, the sliding structure 512 may be a block structure. For another example, as shown in FIG. 6 and FIG. 7, the sliding structure 512 may be an arc protrusion to improve the stability of the sliding structure 512 sliding in the arc slide 511.

In another embodiment, the connection device may include: a fixing assembly 520 disposed between the first sub-body 100 and the first body 10. The first sub-body 100 may be connected to the fixing assembly 520 via a first connection structure 510 of the at least one connection structure 510, and the second body 40 may be connected to the fixing assembly 520 via a second connection structure 510 of the at least one connection structure 510. The first connection structure 510 may include a first arc slide 513 and a first sliding structure 514 inserted in the first arc slide 513, and the second connection structure 510 may include a second arc slide 515 and a second sliding structure 516 inserted in the second arc slide 515. The axis B of the second arc slide 515 and the axis C of the first arc slide 513 may be parallel and may be arranged at intervals. The axis C of the first arc slide 513 may be located on the side of the first sub-body 100, and the axis B of the second arc slide 515 may be located on the side of the second body 40. The first sub-body 100 may move relative to the second body 40 along the track defined by the first arc slide 513 and the second arc slide 515 through the first arc slide 513 sliding in the first sliding structure 514 and the second sliding structure 516 sliding in the second arc slide 515, such that the distance between the first edge portion 1111 and the second edge portion 4111 may be the same in the first state and the second state.

In this example, since the axis C of the first arc slide 513 may be located on the side of the first sub-body 100 and the axis B of the second arc slide 515 may be located on the side of the second body 40, during the rotation of the first sub-body 100 relative to the second body 40, the first arc slide 513 and the second arc slide 515 may cooperate to adapt the distance that the first sub-body 100 may be moved away from or close to the second body 40 in the area of the connection device 50 relative to the second body 40, such that the stroke of each slide may be reduced and the setting space of each slide may be reduced. Therefore, the thickness of the first sub-body 100 and the thickness of the second body 40 may be reduced, and the overall thinness of the electronic device may be achieved.

In this example, in the first state, the distance between the first arc slide 513 and the first top wall 110 may be smaller than the distance between the second arc slide 515 and the second top wall 410. The first arc slide 513 may be located closer to the first top wall 110.

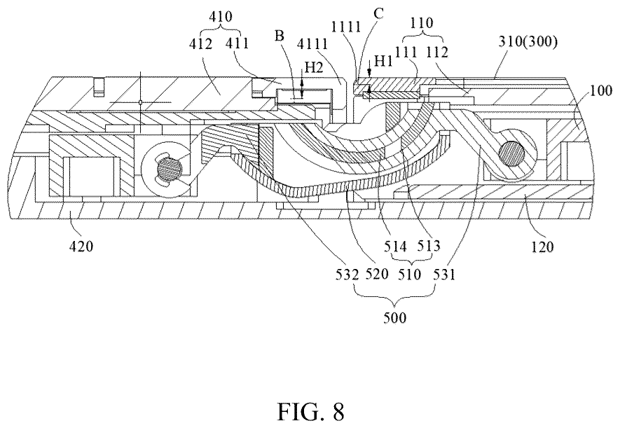

Since the first sub-body 100 may be only provided with the thin flexible screen 300 on the side of the first top wall 110, the side of the first top wall 110 may have more space to accommodate the connection structures 510. When the second body 40 may be provided with the input component 412, the second arc slide 515 may be located farther away from the second top wall 410 side, to reserve more space for the input component 412. As an example, as shown in FIG. 8, the distance H1 between the axis C of the first arc slide 513 and the first top wall 110 may be smaller than the distance H2 between the axis B of the second arc slide 515 and the second top wall 410, such that the first arc slide 513 may be located closer to the side of the first top wall 110.

In one embodiment, the first arc slide 513 and the second arc slide 515 may be round-arc slides 511. The diameter of the first arc slide 513 and the diameter of the second arc slide 515 may be the same or different. The structures of the first sliding structure 514 and the second sliding structure 516 may be similar to the above-mentioned sliding structure 512, and will not be repeated here. As an example, the first sliding structure 514 may be a first arc protrusion, and the second sliding structure may be a second arc protrusion.

In one embodiment, during the movement of the first sub-body 100 and the second body 40 from the first state to the second state through the connection device 50, the distance between the first edge portion 1111 and the second edge portion 4111 may first decrease and then increase. As an example, during the movement of the first sub-body 100 and the second body 40 from the first state to the second state through the connection device 50, the distance deviation between the first side 1111 and the second side 4111 may be less than 0.2 mm. Therefore, the user may not notice the change in the distance between the first side 1111 and the second side 4111 with the naked eye, such that the adjacent areas of the first sub-body 100 and the second body 40 may be in a more uniform appearance.

In one embodiment, the first arc slide 513 may be disposed in the fixing assembly 520 or the first sub-body 100, and the second arc slide 515 may be set in the fixing assembly 520 or the second body 40.

As an example, the fixing assembly 520 may accommodate the first sliding structure 514 and the second sliding structure 516 arranged at intervals in the axial direction. A portion of the first arc slide 513 may be located in the first sub-body 100, and a portion of the second arc slide 515 may be located in the second body 40.

The first sliding structure 514 and the second sliding structure 516 may be symmetrically arranged on the fixing assembly 520, and the diameter of the first arc slide 513 and the diameter of the second arc slide 515 may be the same, to facilitate processing and manufacturing.

Of course, in some other embodiments, the diameter of the first arc slide 513 and the diameter of the second arc slide 515 may also be different. For example, the diameter of the first arc slide 513 may be larger than the diameter of the second arc slide 515, and the size of the first arc slide 513 in the thickness direction of the first sub-body 100 may be larger than the size of the second arc slide 515 in the thickness direction of the second body 40. The size of the first arc slide 513 may be larger than the size of the second arc slide 515, which may reduce the space for setting the second arc slide 515 in the second body 40 and the arc slide 511 with a larger diameter may be set on the side with larger space. For example, the second body 40 may be provided with the input component 412, and the input component 412 may occupy a certain space in the thickness direction of the second body 40. The flexible screen 300 on the first sub-body 100 may be relatively thin, such that the first sub-body 100 may have more space to set one large-diameter arc slide 511. The overall thinner setting of the electronic device may be achieved, and the electronic device may be thinned.

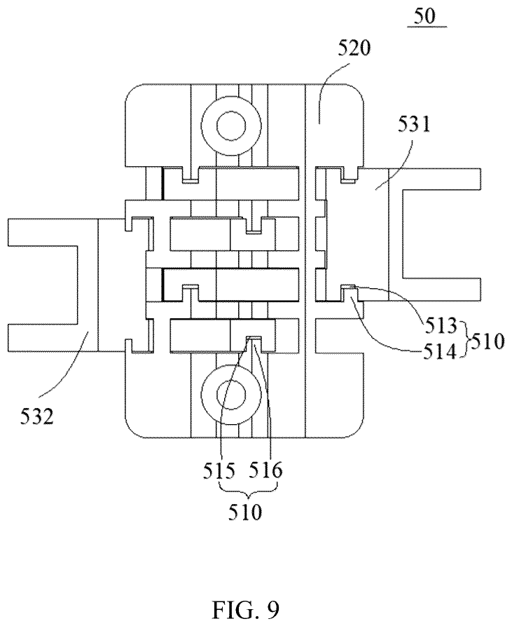

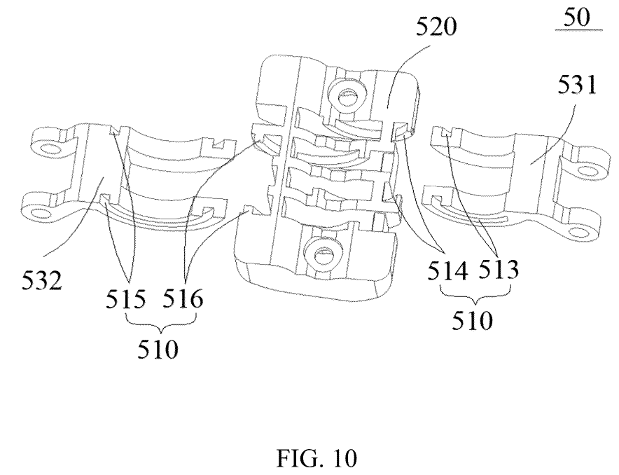

In one embodiment, as shown in FIG. 8, FIG. 9 and FIG. 10, the connection device 50 may also include: a first connection member 531 and a second connection member 532. The first connection member 531 may be used to connect the first sub-body 100 and the first arc slide 513, and the second connection member 532 may be used to connect the second body 40 and the second arc slide 515.

A first end of the first connection member 531 may be provided with the first arc slide 513, and a second end of the first connection member 531 may be connected to the first sub-body 100. A first end of the second connection member 532 may be provided with the second arc slide 515, and a second end of the second connection member 532 may be connected to the second body 40. The second end of the first connection member 531 may not slide with the first sub-body 100, and the second end of the second connection member 532 may not slide with the second body 40. Of course, in some other embodiments, the first arc slide 513 may also be directly provided on the first sub-body 100, and the second arc slide 515 may also be directly provided on the second body 40.

In one embodiment, the connection device 50 may also include: a damping structure, which may be arranged between the sliding structures 512 and the arc slides 511. The damping structure may be used to provide a first damping force to the first sub-body 100 when the first sub-body 100 moves relative to the second body 40. A torque provided by the first damping force to the first sub-body 100 may be larger than a torque provided by the gravity of the first body 10 to the first sub-body 100.

After an external force pushes the first sub-body 100 to rotate relative to the second body 40 by a set angle, when the external force is removed, the first sub-body 100 may no longer rotate relative to the second body 40 based on the fact that the torque provided by the first damping force to the first sub-body 100 is larger than the torque provided by the gravity of the first body 10 to the first sub-body 100, thereby being able to stably maintain the rotation angle of the first sub-body 100 relative to the second body 40.

The form of the damping structure is not limited in the present disclosure. For example, in one embodiment, the damping structure may be an elastic friction sheet disposed between the sliding structure 512 and the arc slide 511. When an external force causes the first sub-body 100 to rotate relative to the second body 40, the elastic friction sheet may be deformed into the same shape as the arc slide 511, such that the elastic friction sheet does not affect the relative sliding between the sliding structure 512 and the arc slide 511. When the external force is removed, the elastic friction sheet may be deformed. The shape of the elastic friction sheet may be different from that of the arc slide 511. The elastic friction sheet may contact the sliding structure 512 and the arc slide 511, respectively, to provide the first damping force. For another example, the damping structure may be a friction protrusion disposed on the contact surface of the sliding structure 512 and the arc slide 511, and the first damping force may be provided by the friction protrusion.

In one embodiment, the connection device 50 may further include: a rotating shaft assembly 550, a third connection member 533, and a fourth connection member 534. The rotating shaft assembly 550 may be disposed between the first sub-body 100 and the second body 40. The rotating shaft assembly 550 may include at least two connecting shafts rotatably disposed on the fixing assembly 520 of the connection device 50. Adjacent connecting shafts among the at least two connecting shafts may be rotatably matched and connected. A first end of the third connection member 533 may be fixedly connected to the first connecting shaft 551 on the first side of the at least two connecting shafts. A second end of the third connection member 533 may be slidably connected to the first sub-body 100. A first end of the fourth connection member 534 may be fixedly connected to the second connecting shaft 552 on the second side of the at least two connecting shafts. A second end of the fourth connection member 534 may be slidably connected to the second body 40.

When the first sub-body 100 rotates relative to the second body 40, the third connection member 533 may drive the first connecting shaft 551 to rotate and may also translate relative to the first sub-body 100, and the fourth connection member 534 may drive the second connecting shaft 552 to rotate and may also translate relative to the second body 40, to adapt to the relative movement of the second body 40 and the first sub-body 100 in the area of the connection device 50. Also, the first connecting shaft 551 and the second connecting shaft 552 may rotate relative to each other to adapt to the angle of relative rotation of the second body 40 and the first sub-body 100. The rotating shaft assembly 550 and the connecting structure 510 may be arranged at intervals in the axial direction, and the first sub-body 100 and the second body 40 may be connected by two sets of structures to improve the stability of the rotation of the first sub-body 100 relative to the second body 40. Of course, in other examples, the electronic device may also provide the stability of the rotation of the first sub-body 100 relative to the second body 40 by arranging two sets of spaced connecting structures 510 in the axial direction. In some other embodiments, the connection device 50 of the electronic device may include only the shaft assembly 550, the third connection member 533 and the fourth connection member 534, but not the connecting structures 510. The shaft assembly 550, the third connection member 533 and the fourth connection member 534 may also realize the hidden setting of the connection device 50.

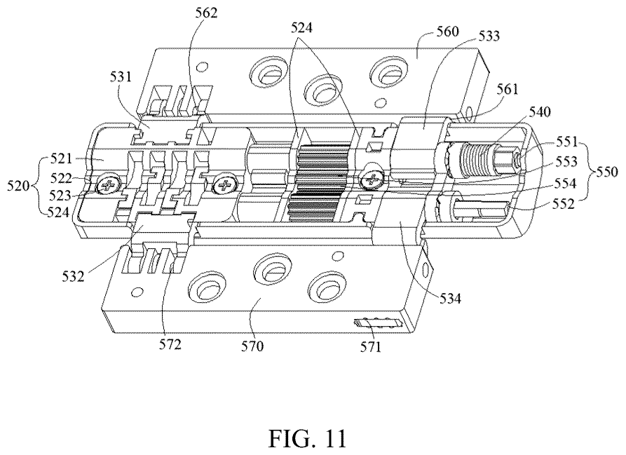

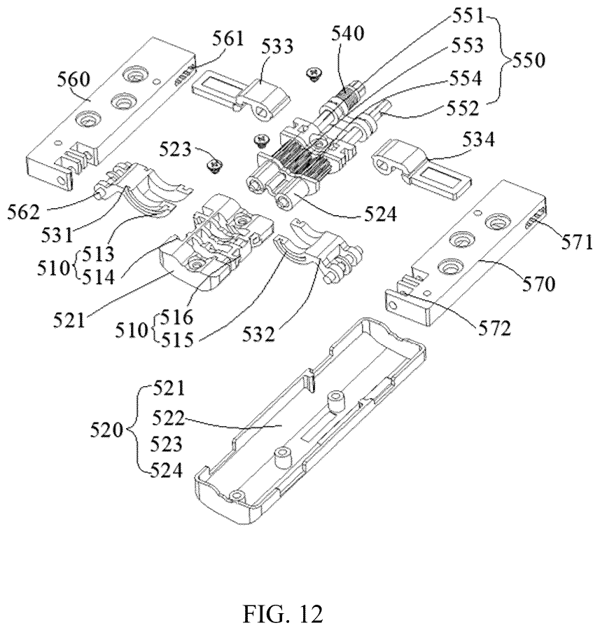

Adjacent connecting shafts among the at least two connecting shafts may be rotatably matched and connected, to adapt to the rotation angle of the first sub-body 100 relative to the second body 40 during the rotation. Also, adjacent connecting shafts among the at least two connecting shafts may also provide a damping force for rotation of the shaft assembly 550. Of course, the connection device 50 may also include a damping plate group 540, which may be arranged on one connecting shaft to provide a damping force for rotation. As an example, as shown in FIG. 11 and FIG. 12, the damping plate group 540 may be arranged on the first connecting shaft 551. It should be noted that the connection device 50 may only be provided with a damping structure between the sliding structure 512 and the arc-shaped slide 511. The connection device 50 may also not be provided with a damping structure between the sliding structure 512 and the arc slide 511. The connection device 50 may provide a damping force for rotation by rotatably cooperating and connecting the damping plate group 540 at the rotating shaft assembly 550 and adjacent connecting shafts.

The implementation method of rotatably setting the at least two connecting shafts on the fixing assembly 520 of the connection device 50 is not limited in the present disclosure.

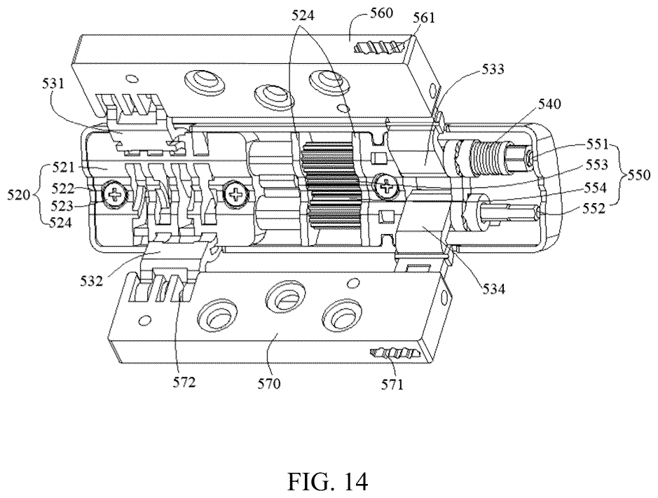

For example, as shown in FIG. 11 and FIG. 12, the fixing assembly 520 may include a sleeve 524, and the at least two connecting shafts may be rotatably set on the sleeve 524. As shown in FIG. 11, FIG. 12, and FIG. 14, the fixing assembly 520 may also include a body 521, a shell 522, and a fastener 523. The sleeve 524 and the body 521 may be fixed to the shell 522 by the fastener 523. The connecting structure 510 may be disposed on the body 521.

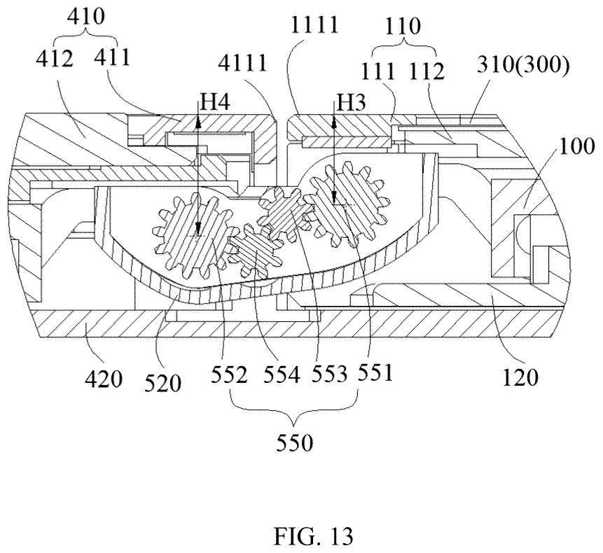

The number of the at least two connecting shafts is not limited. For example, the number of the at least two connecting shafts may be two. For another example, the number of the at least two connecting shafts may be four. As an example, as shown in FIG. 11, FIG. 12, FIG. 13 and FIG. 14, the shaft assembly 550 may include a first connecting shaft 551, a second connecting shaft 552, a third connecting shaft 553 and a fourth connecting shaft 554. For yet another example, the number of the at least two connecting shafts may be six.

The implementation method of matching and connecting of the adjacent connecting shafts of the at least two connecting shafts is not limited. For example, the adjacent connecting shafts may be rotatably matched through a gear structure. As an example, as shown in FIG. 11, FIG. 12, FIG. 13, and FIG. 14, a gear portion may be provided on the outer side of each connecting shaft, and gear portions of adjacent connecting shafts may be meshed. For another example, the adjacent connecting shafts may be rotatably matched through a convex-concave structure provided on the outer peripheral side of the connecting shafts.

The second end of the third connection member 533 may be disposed on the first sub-body 100 through a slide structure or a slide rail structure. The second end of the fourth connection member 534 may be disposed on the second body 40 through a slide structure or a slide rail structure.

In one embodiment, as shown in FIG. 11, FIG. 12 and FIG. 14, the connection device 50 may further include a first fixing member 560 and a second fixing member 570. The first fixing member 560 may be fixed to the first sub-body 100 by a snap connection, or a threaded structure, etc. The first fixing member 560 may have a first guide groove 561 and a first fixing shaft 562 arranged at intervals along the axial direction. The second end of the third connection member 533 may be inserted into the first guide groove 561. The second end of the first connection member 531 may be rotatably connected to the first fixing shaft 562. The second fixing member 570 may be fixed to the second body 40 by means of a snap connection, a threaded structure, etc. The second fixing member 570 may have a second guide groove 571 and a second fixing shaft 572 arranged at intervals along the axial direction. The second end of the fourth connection member 534 may be inserted into the second guide groove 571. The second end of the second connection member 532 may be rotatably connected to the second fixing shaft 572. The connecting structure 510 and the rotating shaft assembly 550 may be formed into the connection device 50 with an integral structure through the first fixing member 560 and the second fixing member 570, to facilitate the overall installation of the connection device 50. In one embodiment, when the electronic device may be provided with at least two sets of the connection devices 50 in the axial direction, the two sets of the connection devices 5 may be assembled first, and then the two sets of the connection devices 50 may be installed as a whole between the first sub-body 100 and the second body 40 at intervals, which may be easy to operate.

In some other embodiments, the connection device 50 may not be provided with the first fixing member 560 and the second fixing member 570. Alternatively, in some other embodiments, the connection device 50 may also be provided with only one of the first fixing member 560 and the second fixing member 570.

The second end of the first connection member 531 may be rotatably connected to the first fixing shaft 562, and the second end of the second connection member 532 may be rotatably connected to the second fixing shaft 572, to prevent the first sub-body 100 from getting stuck during the rotation process relative to the second body 40. In some other embodiments, the second end of the first connection member 531 may also be fixedly connected to the first fixing shaft 562, and the second end of the second connection member 532 may also be fixedly connected to the second fixing shaft 572. It should be noted that, when the connection device 50 does not include the shaft assembly 550, the third connection member 533 and the fourth connection member 534, but includes the first connection member 531 and the second connection member 532, the first connection member 531 may be rotatably arranged on the first sub-body 100 or may be fixed to the first sub-body 100; the second connection member 532 can be rotatably arranged on the second body 40, and the second connection member 532 may also be fixed to the second body 40, such that the first connection member 531 and the second connection member 532 are able to rotate relative to each other during the rotation of the first sub-body 100 relative to the second body 40.

In some optional embodiments, the second bottom wall 420 of the second body 40 may be used to contact the bearing surface. A portion of the second bottom wall 420 may at least extend to the corresponding position of the first sub-body 100 and the connection device 50, such that the second bottom wall 420 of the second body 40 increases the contact area between the electronic device and the bearing surface in the second state, thereby improving the stability of supporting the electronic device, as shown in FIG. 4 and FIG. 5.

In one embodiment, the thickness of the second body 40 at the connection device 50 may be larger than the thickness of the first sub-body 100 at the connection device 50, as shown in FIG. 8.

In one embodiment, the width of the second bottom wall 420 extending to the side of the first sub-body 100 may be larger than half of the width of the first sub-body 100, that is, the width of the second bottom wall 420 extending to the side of the first sub-body 100 may be larger than half the width of the first sub-body 100, such that the electronic device is mainly supported by the second bottom wall 420.

The first bottom wall 120 of the first sub-body 100 may not be used to contact the bearing surface, as long as the second bottom wall 420 is in contact with the bearing surface to support the electronic device.

As shown in FIG. 3, the second bottom wall 420 may be provided with a first group of foot pads 610 and a second group of foot pads 620 at intervals in the width direction. The first group of foot pads 610 may be located close to the side of the first sub-body 100, and the second group of foot pads 620 may be located away from the side of the first sub-body 100. When the first bottom wall 120 is also used to contact the bearing surface, the first bottom wall 120 may also need to be provided with foot pads. By setting the second bottom wall 420 to have a larger size in the width direction, it may not be necessary to provide foot pads on the first bottom wall 120, and the foot pad structure may be simplified.

In one embodiment, as shown in FIG. 13, when the connection device 50 includes the rotating shaft assembly 550, the distance H3 between the first side 1111 and the first connecting shaft 551 in the thickness direction may be less than the distance H4 between the second edge portion 4111 and the second connecting shaft 552 in the thickness direction. The first connecting shaft 551 may be closer to the first top wall 110. Since the first sub-body 100 is only provided with the thinner flexible screen 300 on the first top wall 110, the side of the first top wall 110 may have more space for setting the connecting structure 510. When the second body 40 is provided with the input component 412, the second connecting shaft 552 may be located on the side away from the second top wall 410, to reserve more setting space for the input component 412.

In some optional embodiments, as shown in FIG. 1 and FIG. 8, the first top wall 110 may include a first frame portion 111 and a bearing portion 112 for bearing the first part 310. A portion of the first part 310 may be located within the area defined by the first frame portion 111. A portion of the first frame portion 111 close to the second body 40 may form the first edge portion 1111. The second top wall 410 may include a second frame portion 411 and a portion of the input component 412 disposed within the area defined by the second frame portion 411. A portion of the second frame portion 411 close to the first sub-body 100 may form the second edge portion 4111.

The input component 412 and the second frame portion 411 may together form the second top wall 410 of the second body 40. The input component 412 may provide an input function for the electronic device.

In one embodiment, the first edge portion 1111 and the second edge portion 4111 may both be strip structures. The first edge portion 1111 may be disposed on the entire top side area of the first sub-body 100 close to the second body 40, and the second edge portion 4111 may be arranged on the entire top side area of the second body 40 close to the first sub-body 100, such that a straight-line gap is formed between the first sub-body 100 and the second body 40, thereby making the appearance of the connection area between the first sub-body 100 and the second body 40 more neat.

The various specific technical features described in the specific embodiments can be combined in any suitable manner without contradiction. For example, different embodiments and technical solutions can be formed by combining different specific technical features. In order to avoid unnecessary repetition, the various possible combinations of the specific technical features in this application will not be described separately.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An electronic device, comprising a first body and a second body, wherein:
the first body includes: a first sub-body and a second sub-body which are able to rotate relative to each other, and a flexible screen;
the flexible screen includes a first part on the first sub-body, a second part on the second sub-body, and a connection part between the first part and the second part;
the first part and the second part are able to rotate through the connection part as the first sub-body and the second sub-body rotate relative to each other;
the second body is rotatably connected to an end of the first sub-body away from the second sub-body through a connection device;
the second body is able to rotate relative to the first sub-body through the connection device until it satisfies a coplanar condition with the first sub-body;
a part where the connection device is connected to the first sub-body is located between a first top wall and a first bottom wall of the first sub-body; and
a part where the connection device is connected to the second body is located between a second top wall and a second bottom wall of the first body.

2. The device according to claim 1, wherein:
the first top wall includes a first edge portion arranged adjacent to the second body, and the second top wall includes a second edge portion arranged adjacent to the first edge portion;
the second body is able to be rotated to a first state or a second state relative to the first sub-body through the connection device, and a distance between the first edge portion and the second edge portion is the same in the first state and the second state;
in the first state, the second body and the first sub-body satisfy the coplanar condition, and in the second state, an angle between the second body and the first sub-body is larger than or equal to 90 degrees;
the connection device includes: at least one connecting structure, wherein one connecting structure includes an arc slide and a sliding structure inserted into the arc slide; and
the first sub-body moves relative to the second body along a trajectory defined by the arc slide based on the sliding structure sliding in the arc slide, such that the distance between the first edge portion and the second edge portion is the same in the first state and the second state.

3. The device according to claim 2, wherein:
the connection device includes one connecting structure;
an axis of the arc slide is located at the second edge portion;
for one of the arc slide and the sliding structure, a portion is located between the first top wall and the first bottom wall of the first sub-body, and another portion is located outside the first sub-body;
for another one of the arc slide and the sliding structure, a portion is located between the second top wall and the second bottom wall of the second body, and another portion is located outside the second body; and
the first sub-body rotates around the second edge portion by sliding of the sliding structure in the arc slide.

4. The device according to claim 2, wherein:
the connection device includes: a fixing assembly arranged between the first sub-body and the first body;
the first sub-body is connected to the fixing assembly through a first connecting structure of the at least one connecting structure, and the second body is connected to the fixing assembly through a second connecting structure of the at least one connecting structure;
the first connecting structure includes a first arc slide and a first sliding structure inserted in the first arc slide;
the second connecting structure includes a second arc slide and a second sliding structure inserted in the second arc slide;
an axis of the second arc slide and an axis of the first arc slide are parallel and arranged at intervals;
the axis of the first arc slide is located on the side of the first sub-body, and the axis of the second arc slide is located on the side of the second body; and
the first sub-body slides in the first arc slide through the first sliding structure, and the second sliding structure slides in the second arc slide and moves relative to the second body along a trajectory jointly defined by the first arc slide and the second arc slide, such that the distance between the first edge portion and the second portion is the same in the first state and the second state.

5. The device according to claim 4, wherein:
the fixing assembly includes the first sliding structure and the second sliding structure which are arranged at interval along the axial direction;
a portion of the first arc slide is located in the first sub-body, and a portion of the second arc slide is located in the second body;
the first sliding structure and the second sliding structure are symmetrically arranged on the fixing assembly;
a diameter of the first arc slide is the same as a diameter of the second arc slide, or the diameter of the first arc slide is larger than the diameter of the second arc slide; and
a dimension of the first arc slide in a thickness direction of the first sub-body is larger than a dimension of the second arc slide in a thickness direction of the second body.

6. The device according to claim 5, wherein:
the connection device further includes:
a first connection member, used to connect the first sub-body and the first arc slide, wherein the first arc slide is disposed on a first end of the first connection member and a second end of the first connection member is connected to the first sub-body; and
a second connection member, used to connect the second body and the second arc slide, wherein the second arc slide is disposed on a first end of the second connection member and a second end of the second connection member is connected to the second body.

7. The device according to claim 2, wherein:
the connection device further includes: a damping structure between the sliding structure and the arc slide, which is used to provide a first damping force to the first sub-body when the first sub-body moves relative to the second body; and
a torque provided by the first damping force to the first sub-body is larger than a torque provided by the gravity of the first body to the first sub-body.

8. The device according to claim 2, wherein:
the connection device further includes:
a rotating shaft assembly between the first sub-body and the second body, wherein the rotating shaft assembly includes at least two connecting shafts rotatably arranged on the fixing assembly of the connection device and adjacent connecting shafts among the at least two connecting shafts are rotatably matched and connected;
a third connection member, wherein a first end of the third connection member is fixedly connected to a first connecting shaft on a first side of the at least two connecting shafts and a second end of the third connection member is slidably connected to the first sub-body; and
a fourth connection member, wherein a first end of the fourth connection member is fixedly connected to a second connecting shaft on a second side of the at least two connecting shafts and a second end of the fourth connection member is slidably connected to the second body.

9. The device according to claim 8, wherein:
the second bottom wall of the second body is used to contact a bearing surface;
a portion of the second bottom wall extends at least to the corresponding position of the first sub-body and the connection device;
the thickness of the second body at the connection device is larger than the thickness of the first sub-body at the connection device;
a distance between the first edge portion and the first connecting shaft in the thickness direction is less than a distance between the second edge portion and the second connecting shaft in the thickness direction.

10. The device according to claim 2, wherein:
the first top wall includes a first frame portion and a support portion for supporting the first part;
a portion of the first part is located within an area defined by the first frame portion;
a portion of the first frame portion close to the second body forms the first edge portion;
the second top wall includes a second frame portion and a portion of the input component arranged within the area defined by the second frame portion; and
a portion of the second frame portion close to the first sub-body side forms the second edge portion.
